(19) United States
(12) Patent Application Publication
(10) Pub. No.: US 2014/0344577 A1
(43) Pub. Date: Nov. 20, 2014

(54) System, Method and Computer Program Product for Providing Digital Rights Management of Protected Content

(71) Applicant: VITAL SOURCE TECHNOLOGIES, INC., Raleigh, NC (US)

(72) Inventors: William M. Abrams, Searcy, AR (US); Ricky Lee Johnson, Scottsdale, AZ (US)

(73) Assignee: VITAL SOURCE TECHNOLOGIES, INC., Raleigh, NC (US)

(21) Appl. No.: 14/256,596

(22) Filed: Apr. 18, 2014

Related U.S. Application Data
(63) Continuation of application No. 12/352,325, filed on Jan. 12, 2009, now abandoned.
Application No. 12/352,325 is a continuation of application No. 10/860,627, filed on Jun. 4, 2004, now abandoned.

(51) Int. Cl. H04L 29/06; H04L 9/08

(52) U.S. Cl. CPC H04L 63/0428; H04L 9/0816; H04L 2209/24
USPC 713/168

(57) ABSTRACT

A system for providing digital rights management of protected content includes a client and a DRM manager. The client is capable of receiving at least one piece of content, the piece(s) of content being encrypted with at least one encryption key regardless of client user(s) authorized to access the piece(s) of encrypted content. To facilitate the client accessing one or more of the piece(s) of content, the DRM manager is capable of transferring the encryption key(s) to the client, the encryption key(s) being encrypted with a private key of a public key/private key pair unique to a client user associated with the client. The client can thereafter decrypt the encryption key(s) using the public key of the public key/private key pair unique to the client user. Then, the client can decrypt the piece(s) of content using the decrypted encryption key(s), and access the decrypted piece(s) of content.

### FIELD OF THE INVENTION

The present invention generally relates to systems and methods for protecting content and, more particularly, relates to systems, methods and computer program products for providing digital rights management of protected content.

### BACKGROUND OF THE INVENTION

In today's educational climate, an increasing number of persons seek knowledge and further education regarding a truly diverse and wide variety of subjects. As can be appreciated, education and training takes a wide variety of forms. Education starts at a very young age and extends through high school. Thereafter, persons may attend any of a variety of universities, colleges or technical centers. However, education and training is not limited to these formal environments. Illustratively, many companies, agencies and other entities implement training programs to train people with the skills those people need for their respective jobs. Additionally, after receiving a college education, many persons, in an increasingly greater rate, attend some type of graduate school. Graduate schools may include medical school, law school and business school, as well as a wide variety of other advanced curriculums. Even after such higher educations, for example, persons still attend conferences, seminars and other organized meetings to exchange information and ideas.

Accordingly, education and training are present in our lives from a very young age and might never end for some persons. As described above, this education takes a wide variety of forms. However, one common thread running through this education is the necessity to convey information from persons and materials that possess the knowledge, to persons wanting the knowledge. The persons providing the knowledge will hereinafter be referred to as “teachers,” with those persons receiving the knowledge referred to as “students.”

The training environment of a medical student provides insight into the presently used teaching methods. Typically, a medical student starts his or her education with the hope of being enriched by the knowledge he or she seeks. Typically, a medical student may walk into a classroom and, from day one, the lights go out and the slides start flashing on the screen. The rate at which the slides are shown may average as much as 180 slides per hour. Nevertheless, the slides pass by in front of the medical student and she is expected to digest this information.

The information used in teaching may come from numerous sources. For example, the slides shown to the medical students may be the result of years of collecting by a professor. Further, the slides may be one of a kind that the professor obtained from the professor's mentor, who used to be chairman of their department before he retired.

The students correctly perceive those slides as being of tremendous value. However, the students see the slides one time, and only one time, and then the slides are gone forever. After class, then, the students attempt to conjure up the slides either working alone or in groups. The students often unsuccessfully attempt to draw the slides when they are displayed in class. But before the essence of the slide is really captured, the next slide is being displayed. Then, after class the students might approach the professor and humbly request a copy of the slides. However, the slides often represent the career of the professor. As a result, the professor is hesitant to assist in a reproduction of his documents in any form.

The above scenario illustrates one of a variety of situations that prevent the exchange of information and knowledge from a teacher to a student. Accordingly, the scenario results in the students recreating the knowledge to which they were exposed. This recreation might be in the form of notes or crude reproductions of the slides, or whatever other information was presented in class that day. Accordingly, there is a need to provide a method to exchange knowledge from a teacher to a student that is both beneficial and acceptable to all parties.

Alternatively, a situation may be present when the teacher does indeed prepare and provide materials to the students. However, even in this situation there are common problems. For example, a teacher may copy a favorite diagram from a resource book and paste that diagram into their own created materials. The teacher may then surround this copied diagram with the teacher's own text. This, for one, results in potential copyright infringement violations. Also, with the advent of desktop publishing capabilities, the accumulation of these materials is becoming progressively easier. The student accurately perceives this material as coming straight from the professor and, as a result, considers the material of great value. In addition, the university, for example, may require the student to purchase the professor's material. Alternatively, the university will recommend that the student buy a series of materials from a particular publisher.

Accordingly, a situation has developed in the academic world, and in other learning environments, in which administrative persons, faculty members and students are discouraged and concerned with regard to the decreasing quality of their study materials. People are discouraged both from the perspective of a teacher, providing the materials, and from the perspective of a student, receiving the materials. For students, the situation is particularly discouraging in that their command of the material, in testing situations as well as other situations, will dictate the success of their careers.

To address the aforementioned issues, systems have been developed to effectively collect information from a wide variety of sources and provide one or more items of material from this collection to students in an efficient manner. In accordance with one such system, an entire educational curriculum for an organization can be made available to a user in a readily accessible collection. That is, a collection can be characterized as global to a particular organization, such as a college or corporation, including all curriculum materials that the particular organization utilizes. The system can then provide for navigation of information in the collection to thereby permit a user to interact with one or more items of material in the collection as if those item(s) were single textbook(s), journal(s), video(s) or treatise(s), for example.

In such systems, as well as systems that generally provide content, there are some challenges with the protection of content, such as copyrighted content, from access by those not licensed or otherwise authorized to access such content. In an attempt to protect content from unauthorized access, several digital rights management (DRM) techniques have been developed. One such technique, the content scrambling system (CSS) employed by the DVD Consortium on movie DVDs, protects content by encrypting content stored on DVDs with a common secret encryption key. To access such encrypted content, then, DVD players are typically manufactured with knowledge of the encryption key such that the DVD players can decrypt the content and present it for viewing.

Another DRM technique is the FairPlay™ system developed by Apple Computer, Inc. and used in conjunction with its iTunes® music service. In accordance with the FairPlay™ system, each registered user has a unique symmetric key, which the service uses to encrypt each music file licensed for access by the respective user. To obtain a symmetric key, a registered user can communicate information uniquely identifying a device of the user used to download the music files, where the service associates the device identifying information with a unique symmetric key and returns the key to the user.

Whereas conventional DRM techniques such as those described above are adequate in protecting content from unauthorized access, such techniques have drawbacks. In this regard, the CSS technique encrypts all DVDs with the same encryption key, which is known to DVD players capable of decrypting and presenting the content stored thereon. Thus, the CSS technique does not account for making an unauthorized copy of the encrypted contents of a DVD onto another DVD. In such instances, any DVD player capable of decrypting and presenting the content stored on the original DVD is generally also capable of decrypting and presenting the content stored on the unauthorized copy of the DVD.

The FairPlay™ system, on the other hand, encrypts each piece of content with a symmetric key unique to a registered user, where the symmetric key is associated with device identifying information. Thus, while music files can be freely distributed and copied, such files encrypted for access by one user cannot be accessed by an unregistered user without a symmetric key, or by another registered user having a different symmetric key. But whereas uniquely encrypting each piece of content for a licensed user may be sufficient for content of relatively small size, such a technique is generally inadequate for content of significant size. In this regard, uniquely encrypting large pieces of content for each authorized user may require an undesirable amount of time and computing resources. For example, a single music file may require fifteen minutes to uniquely encrypt for 100 users. To uniquely encrypt a single electronic copy of a textbook for the same 100 users, however, may require fifteen minutes per copy, for a total of twenty-five hours.

### SUMMARY OF THE INVENTION

In light of the foregoing background, embodiments of the present invention present an improved system, method and computer program product for providing digital rights management of protected content. In accordance with embodiments of the present invention, one or more pieces of content can be encrypted with one or more encryption keys (e.g., symmetric keys), regardless of users authorized to access such content. The symmetric keys can then be maintained remote from users desiring access to the content. Then, when an authorized user attempts to access the content, the symmetric keys required to decode the content can be uniquely encrypted for the user, and thereafter provided to the user. The user can then decrypt the symmetric keys, and thereafter use the symmetric keys to decrypt, and thus access, the protected content.

According to one aspect of the present invention, a system is presented for providing digital rights management of protected content. The system includes a client and a DRM manager. The client is capable of receiving at least one piece of content, the piece(s) of content being encrypted with at least one encryption key. Advantageously, the piece(s) of content can be encrypted regardless of client user(s) authorized to access the piece(s) of encrypted content. To facilitate the client accessing one or more of the piece(s) of content, the DRM manager is capable of transferring the encryption key(s) to the client, the encryption key(s) being encrypted with a private key of a public key/private key pair unique to a client user associated with the client. Before transferring the encryption key(s), however, the DRM manager can be capable of determining if the client user is authorized to access the piece(s) of content before transferring the encryption key(s) at the client, and if the client user is authorized, transferring the encryption key(s) to the client.

After receiving the encryption key(s), the client can decrypt the encryption key(s) using the public key of the public key/private key pair unique to the client user. Then, the client can decrypt the piece(s) of content using the decrypted encryption key(s), and access the decrypted piece(s) of content. In this regard, at various instances, the client can be capable of receiving a plurality of pieces of content encrypted with a plurality of encryption keys, with the DRM manager capable of transferring the plurality of encryption keys to the client. At such instances, the client can be capable of decrypting the plurality of encryption keys, and for each of the plurality of pieces of content, decrypting the respective piece of content using a respective decrypted encryption key.

Before decrypting the piece(s) of content, however, an access application operating on the client can be capable determining if the client is authorized to decrypt the piece(s) of content. Then, if the client is authorized, the access application can be capable of decrypting the piece(s) of content and accessing the decrypted at least one piece of content. For example, the access application can be capable of determining if the client is authorized to decrypt the piece(s) of content based upon a client identifier uniquely identifying the client.

More particularly, each of a plurality of clients can have a client identifier uniquely identifying the respective client. In such instances, the client can be capable of receiving a license file including the encryption key(s) and a client identifier uniquely identifying the same or a different client, the license file being encrypted with the private key. Accordingly, the access application can be capable of decrypting the license file including the encryption key(s) and the client identifier. The access application can thereafter be capable of determining if the client is authorized to decrypt the piece(s) of content based upon the client identifier in the license file and the client identifier of the client receiving the license file. For example, the access application can be capable of determining if the client identifier in the license file matches the client identifier of the client receiving the license file, and if a match is identified, decrypting the piece(s) of content and accessing the decrypted at least one piece of content.

According to other aspects of the present invention, a client, method and computer program product are presented for providing digital rights management of protected content. In accordance with embodiments of the present invention, piece(s) of content can be encrypted with encryption key(s) regardless of users authorized to access such content. Then, if the client user is authorized to access the piece(s) of content, the symmetric keys can then be uniquely encrypted for, and provided to, the client. The client can then decrypt the symmetric keys, and thereafter use the symmetric keys to decrypt, and thus access, the protected content, with authorization of the client also required in various instances. Thus, unlike the FairPlay™ system described above, embodiments of the present invention need not uniquely encode each piece of content for each user, thus reducing the time required to encode such content, particularly for content having a significant size. And unlike the CSS technique, devices capable of decrypting the content are not all provided with the means to decrypt the content without regard to whether the device user is licensed or otherwise authorized to access the content. Therefore, embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a system of providing digital rights management of protected content, in accordance with one embodiment of the present invention;

FIG. 2 is a block diagram of an entity capable of operating as a client, source and/or DRM manager, in accordance with one embodiment of the present invention;

FIGS. 3A and 3B are flowcharts illustrating various steps in a method of providing digital rights management of protected content, in accordance with an embodiment of the present invention; and

FIG. 4 is a flowchart illustrating various steps in a method of receiving and encrypting content, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

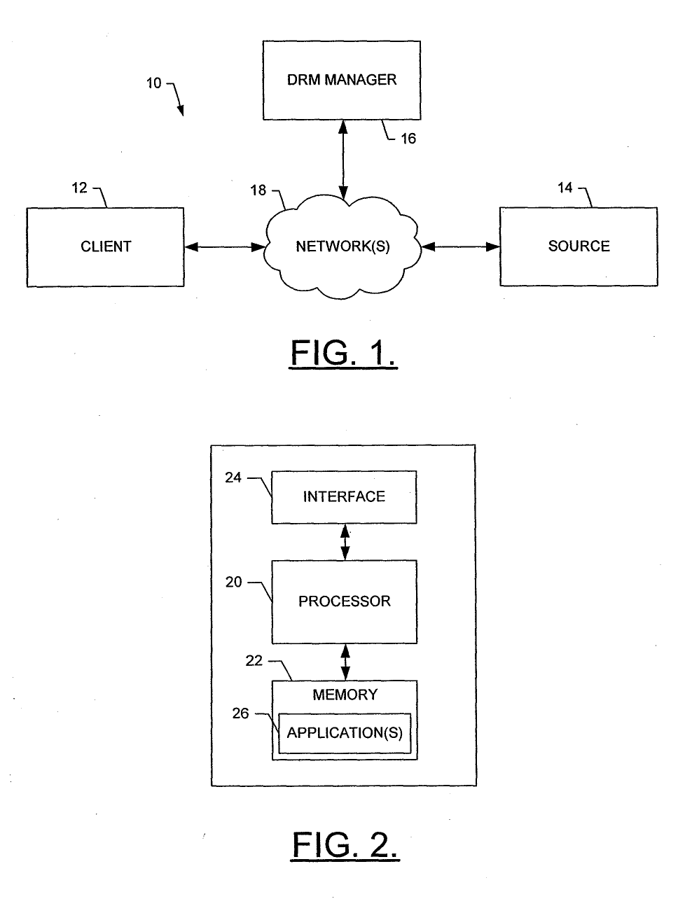

Referring to FIG. 1, a system 10 for providing digital rights management (DRM) of protected content includes one or more clients 12, sources of content 14 and DRM managers 16 (one of each being shown). Each client is capable of directly and/or indirectly communicating with one or more sources of content and DRM managers. Similarly, each source is capable of directly and/or indirectly communicating with one or more clients and DRM managers; and each DRM manager is capable of directly and/or indirectly communicating with one or more clients and sources of content. In this regard, the clients, sources of content and DRM managers can be capable of directly and/or indirectly communicating with one another across one or more networks 18. The network(s) 18 can comprise any of a number of different combinations of one or more different types of networks. For example, the network(s) 18 can include one or more data networks, such as a local area network (LAN), a metropolitan area network (MAN), and/or a wide area network (WAN) (e.g., Internet), can include one or more wireline and/or wireless voice networks including a wireline network, such as a public-switched telephone network (PSTN), and/or wireless networks such as IS-136 (TDMA), GSM, and/or IS-95 (CDMA). For purposes of illustration, however, as described below, the network comprises the Internet (i.e., WAN) unless otherwise noted.

The client 12, source 14 and DRM manager 16 can comprise any one or more of a number of different entities, devices or the like capable of operating in accordance with embodiments of the present invention. In this regard, one or more of the client 12, source 14 and DRM manager 16 can comprise, include or be embodied in one or more processing elements, such as one or more of a laptop computer, desktop computer, server computer or the like. Additionally or alternatively, one or more of the client 12, source 14 and DRM manager 16 can comprise, include or be embodied in one or more portable electronic devices, such as one or more of a mobile telephone, portable digital assistant (PDA), pager or the like. For example, the client 12, source 14 and DRM manager 16 can each comprise a processing element capable of communicating with one another across the Internet (i.e., network 18). It should be understood, however, that one or more of the client 12, source 14 and DRM manager 16 can comprise or otherwise be associated with a user carrying out one or more of the functions of the respective entity. Thus, as explained below, the term “client” can refer to a client 12 and/or client user, and vice versa. Similarly, the term “source” can refer to a source 14 and/or source user, or vice versa; and the term “DRM manager” can refer to a DRM manager 16 and/or DRM manager user, or vice versa.

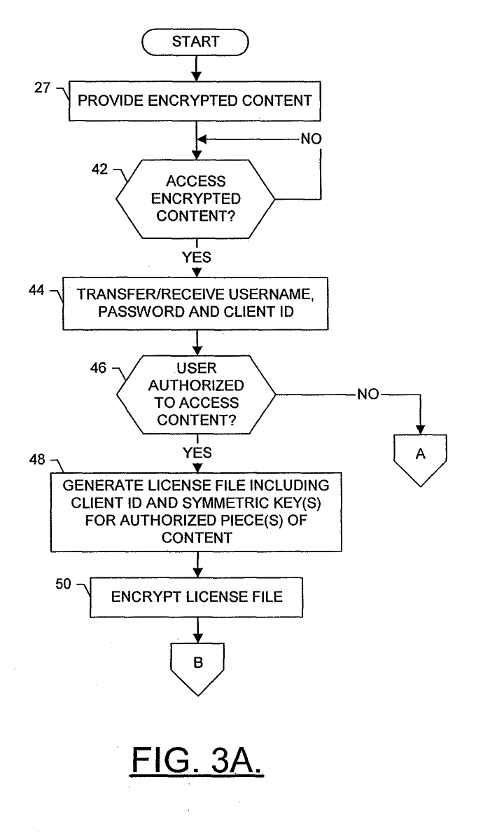

Referring now to FIG. 2, a block diagram of an entity capable of operating as a client 12, source 14 and/or DRM manager 16 is shown in accordance with one embodiment of the present invention. Although shown as separate entities, in some embodiments, one or more entities may support one or more of a client 12, source 14 and/or DRM manager 16, logically separated but co-located within the entit(ies). For example, a single entity may support a logically separate, but co-located, source 14 and DRM manager 16. It should also be appreciated that one or more entities may be capable of performing one or more functions of one or more other entities. In this regard, a source 14 may be capable of performing one or more functions of a DRM manager 16. Additionally, or alternatively, a DRM manager 16 may be capable of performing one or more functions of a source 14.

As shown, the entity capable of operating as a client 12, source 14 and/or DRM manager 16 can generally include a processor 20 connected to a memory 22. The processor 20 can also be connected to at least one interface 24 or other means for transmitting and/or receiving data, content or the like. In this regard, the interface(s) can include a user interface that can include a display and a user input interface. The user input interface, in turn, can comprise any of a number of devices allowing the entity to receive data from a user, such as an electronic scanner, keyboard, mouse and/or any of a number of other devices components or the like capable of receiving data, content or the like.

The memory 22 can comprise volatile and/or non-volatile memory, and typically stores content, data or the like. In this regard, the memory 22 typically stores software applications 26, instructions or the like for the processor 20 to perform steps associated with operation of the entity in accordance with embodiments of the present invention. For example, as explained below, when the entity comprises a client 12, the memory can store client software applications such as an access application for accessing content provided by the source 14, as well as a private key for decrypting data from the DRM manager 16.

When the entity comprises a DRM manager 16, the memory 22 can store, for example, one or more databases such as a user database and an encryption key database. In this regard, the user database can store information relating to client users licensed or otherwise authorized to access content provided by the source 14. The encryption key database can store encryption keys, such as symmetric keys, required to decrypt content provided by the source 14. In this regard, as explained herein, various cryptography techniques may be applied during operation of the system 10 of embodiments of the present invention. It should be understood, however, that those cryptography techniques are merely illustrative, and that any of a number of alternative cryptography techniques may be applied as appropriate, without departing from the spirit and scope of the present invention.

In accordance with embodiments of the present invention, the source 14 is generally capable of providing one or more pieces of content to one or more clients 12. For example, the source 14 can be capable of providing one or more pieces of educational curriculum for an organization in a readily accessible collection. In such instances, the collection can be characterized as global to a particular organization, such as a college or corporation, including a plurality of curriculum materials that the particular organization utilizes. It should be understood, however, that curriculum materials are only one of a number of different types of content, information, data or the like that the source 14 is capable of providing to the client(s) 12. Thus, as used herein, the terms “curriculum materials,” “content,” “information,” and “data” can be used interchangeably to refer to that provided by the source 14 to the client(s) 12.

Briefly, and as explained below, before providing content to the client(s) 12, the source 14 is capable of encrypting, or communicating with the DRM manager 16 such that the DRM manager 16 encrypts, one or more pieces of the content with one or more different symmetric keys. Advantageously, the content can be encrypted regardless of the client users 12 licensed or otherwise authorized to access such content. Thus, the encrypted piece(s) of content can then be freely distributed to one or more clients or client users 12 without regard to whether the respective client user(s) are licensed or otherwise authorized to access the content.

To decrypt and thus access a piece of the content, the client 12 of an authorized or otherwise licensed client user is capable of operating an access application, where the access application is capable of retrieving the respective symmetric key(s) from a DRM manager 16. In this regard, the DRM manager 16 is generally capable of maintaining, remote from the clients, the symmetric keys used to decrypt the content. The DRM manager 16 can determine if the respective client user 12 is permitted to access the respective piece of content. Then, if the client user 12 is licensed or otherwise authorized to access the respective piece of content, the DRM manager 16 can transfer, to the access application, the symmetric key required to decrypt the respective piece of content. Thereafter, the access application can be capable of decrypting the piece of content, and accessing the decrypted piece of content, such as by rendering the piece of content for display to the client user.

As described herein, the access application comprises software (i.e., software application 26) capable of operating on the client 12. It should be understood, however, that the access application can alternatively be embodied in firmware, hardware or the like. Further, although the access application is shown and described herein as operating on the client 12, it should be understood that the access application can be capable of operating on an entity (e.g., personal computer, laptop computer, server computer, etc.) distributed from, and in communication with the client, such as across the Internet (i.e., network 18).

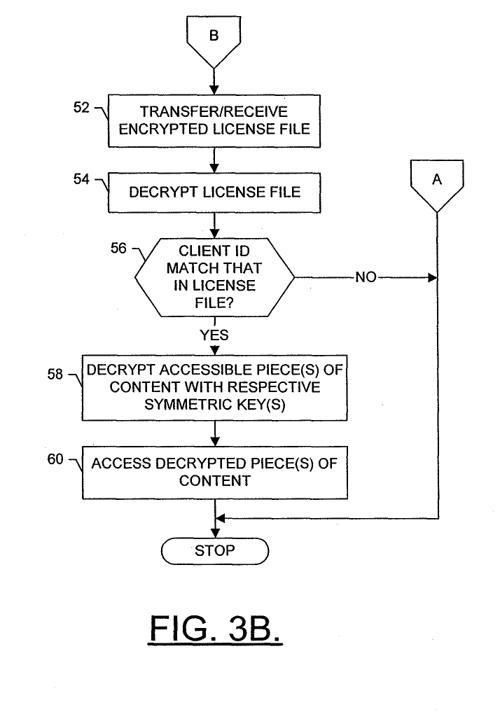

Reference is now made to FIGS. 3A and 3B, which illustrate a flowchart of a method of providing digital rights management (DRM) of protected content. The method includes the source 14 providing one or more pieces of encrypted content to one or more clients 12, such as one or more pieces of curriculum materials, as shown in block 27. In this regard, the source 14 can directly provide the encrypted piece(s) of content to one or more clients 12. Alternatively, the source can indirectly provide the encrypted piece(s) of content to one or more clients 12, such as via any one or more of a number of distributors or other providers of such content from the source 14. Irrespective of whether the source directly or indirectly provides the content to the client(s) 12, the source 14 can provide the content in any of a number of different manners.

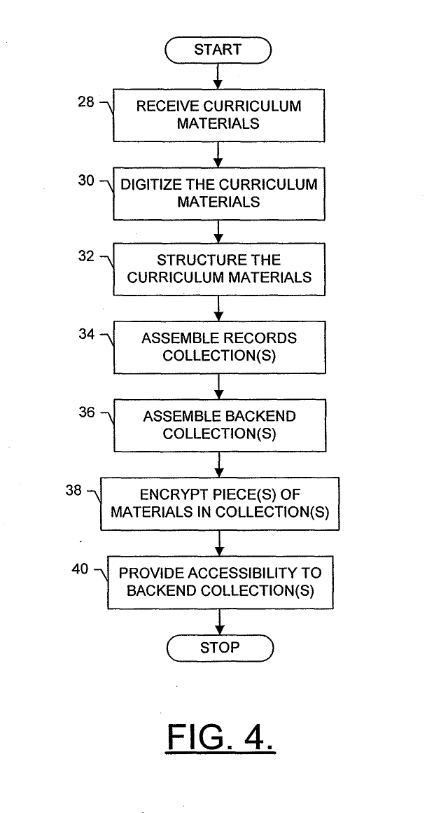

In one advantageous embodiment for providing encrypted curriculum materials, for example, the source 14 is capable of receiving curriculum materials via a user input interface (i.e., interface 24) of the source, as shown in block 28 of FIG. 4, which illustrates various steps in a method of receiving and encrypting content in accordance with one exemplar embodiment of the present invention. After receiving the curriculum materials, the source 14 can store the received materials in memory (i.e., memory 22) of the source. Also after receiving the curriculum materials, as shown in block 30, the source 14 can format and digitize the curriculum materials. Thereafter, the source 14 can facilitate a source user in structuring the curriculum materials, or otherwise structure the curriculum materials, as shown in block 32. For example, the source 14 can structure or otherwise mark-up the curriculum materials in accordance with the Extensible Markup Language (XML). It should be understood, however, that the source 14 can structure the curriculum materials in accordance with any of a number of other markup languages, formats or the like.

After the source 14 marks up the curriculum materials, the source can assemble one or more “records collections,” each identifying one or more pieces of curriculum materials of particular interest to one or more client users, as shown in block 34. In one typical scenario, curriculum materials of interest to a plurality of different client users are stored in memory (e.g. memory 22) of the source 14. In such instances, the curriculum materials stored in memory of the source can then be used to generate one or more backend collections, or subsets of the curriculum materials, for one or more client users. Before forming the backend collection(s), however, the source 14 can generate one or more records collections.

To generate a records collection, the source 14 can first assemble or otherwise receive a list of one or more pieces of curriculum materials desired by or otherwise of particular interest to one or more client users. For example, for client users comprising students of an anatomy class, the list of curriculum materials may include the textbook, ANATOMY OF THE HUMAN BODY by Henry Gray. Additionally, or alternatively, the list of curriculum materials may include other text, video and/or audio content of particular interest to such students. Irrespective of the piece(s) of curriculum materials listed, for the listed piece(s) of curriculum materials, the source 14 can thereafter add the listed piece(s) of curriculum materials, or at least those listed piece(s) of curriculum materials that are stored in memory (i.e., memory 22) of the source or otherwise obtainable, to a particular record collection. In this regard, once the source 14 determines that a piece of curriculum material is stored in memory or is otherwise obtainable, the source can retrieve and add that piece of curriculum material to the respective record collection. Once completed, the respective record collection, including all available piece(s) of curriculum materials, can be stored in memory of the source 14.

As indicated above, after generating one or more records collections, the source 14 can assemble one or more accessible backend collections based upon the generated records collection(s), as shown in block 36. Initially, in instances where the source 14 generates or otherwise stores records collections including curriculum materials desired or otherwise of particular interest to a number of different client users, the source 14 can receive input selecting a particular records collection. Upon receiving the selection of a particular records collection, the source 14 can retrieve, from the memory 14, the selected records collection including at least one piece of curriculum material. Then, the source 14 can proceed to add the piece(s) of curriculum material in the records collection to an accessible backend collection. Before, as or after the source 14 adds the piece(s) of curriculum material to the backend collection, however, the source can encrypt the piece(s) of curriculum material, as shown in block 38. The source 14 can encrypt the piece(s) of curriculum material in any of a number of different manners. In one typical embodiment, for example, the source 14 encrypts the piece(s) of curriculum material with a symmetric key in accordance with any of a number of different symmetric cryptography techniques. Irrespective of how the piece(s) of curriculum material are encrypted, however, the source 14 can thereafter store the backend collection in memory (i.e., memory 22) of the source.

After assembling one or more backend collections, the source 14 can provide, or otherwise facilitate providing, the backend collection(s) including the encrypted piece(s) of curriculum material, as shown in block 40. In this regard, the backend collection(s) can be provided in any of a number of different manners. For example, one or more backend collections can be stored on a removable electronic storage medium such as a diskette, CD or, more typically, a DVD. The DVD(s) can then be provided to one or more client users, or more particularly, those client users particularly interested in the piece(s) of content materials of the backend collection(s) stored on the respective DVD(s). Alternatively, for example, one or more backend collections can be stored or otherwise maintained by the source 14 or another processor (e.g., server computer) accessible by one or more client users across one or more networks 18. For more information on such a technique for providing content, see PCT Patent Application Publication No. WO 02/17276 A1 entitled: System and Method for Providing a Curriculum Repository, filed Aug. 8, 2001, the contents of which are hereby incorporated by reference in its entirety.

Again referring to FIG. 3A, irrespective of how the source 14 provides encrypted piece(s) of content to the client(s) 12 or client user(s), at one or more instances thereafter, one or more client users may desire to access one or more of the encrypted piece(s) of content, as shown in block 42. For example, the client user(s) may desire to access encrypted piece(s) of content via an access application (i.e., software application 26) capable of operating on the client 12, such as to view the piece(s) of content. In this regard, the access application can be provided by the source 14 along with the content (e.g., on the same DVD), and thereafter installed and executed to operate on the client 12 to access the piece(s) of content. Alternatively, the access application can be previously installed on the client 12 such that the access application need only be executed to operate on the client to access the piece(s) of content. However, before the client user(s) are permitted to access the encrypted piece(s) of content, the client 12, or more particularly the access application, must typically decrypt the piece(s) of content.

To facilitate only licensed or otherwise authorized client users in decrypting, and thus accessing, piece(s) of content, the DRM manager 16 can be capable of controlling access to the symmetric key(s) required to decrypt the piece(s) of content. In this regard, the source 14 can communicate with the DRM manager 16 to thereby provide the DRM manager with the symmetric key(s) utilized to encrypt the piece(s) of content, typically before the source provides the encrypted content to the client(s). Upon receipt, the DRM manager 16 can store the symmetric keys in the encryption key database (i.e., memory 22).

Further, the client user can register with the DRM manager 16, providing information to the DRM manager sufficient to inform the DRM manager of encrypted piece(s) of content the client user is licensed or otherwise authorized to access. Additionally or alternatively, the source 14 can communicate with the DRM manager 16 to thereby inform the DRM manager of one or more encrypted pieces of content and one or more client users licensed or otherwise authorized to access the respective piece(s) of content. Irrespective of how the DRM manager 16 is informed of the client users licensed or otherwise authorized to access the encrypted piece(s) of content, the DRM manager can store the information relating to client users licensed or otherwise authorized to access the encrypted piece(s) of content in a user database. Also, in such instances, when the client user is licensed or otherwise authorized to access encrypted piece(s) of content, the DRM manager 16 or source 14 can provide the client 12 or client user with a username and password associated with the client user, as well as a private key of a public key/private key pair, which a respective client can store in memory. In this regard, the private key provided to the client user can be unique to the client 12 or client user.

When a client user desires to access one or more of the encrypted piece(s) of content provided by the source 14, then, the respective client 12, or more particularly an access application (i.e., software application 26) operating on the client, can be configured to request access to the encrypted piece(s) of content, such as by requesting the symmetric key(s) required to decrypt the encrypted piece(s) of content. In this regard, the access application can be configured to transfer the client user's username and password to the DRM manager 16 to thereby authenticate the client user to the DRM manager, as shown in block 44.

As will be appreciated, at various instances it may be desirable to further ensure that only a licensed or otherwise authorized client user accesses the encrypted piece(s) of content. In such instances, the system may require that the client 12 of the respective client user be authorized to decrypt the encrypted piece(s) of content, in addition to requiring that the client user be licensed or otherwise authorized to access the encrypted piece(s) of content. In such instances, the access application can be required to transfer a client ID (identifier) unique to the client 12 of the client user, in addition to transferring the client user's username and password. For example, when the client 12 comprises a personal computer, the access application can transfer a client ID generated based upon characteristics of the personal computer, including the hardware of the personal computer, and/or the software applications configured or otherwise installed to operate on the personal computer.

Upon receipt of the username/password and client ID, the DRM manager 16 can search the user database (i.e., memory 22) to determine if the client user is licensed or otherwise authorized to access one or more encrypted pieces of content, or more particularly, one or more encrypted pieces of content having a symmetric key stored in the encryption key database of the DRM manager. If the client user is not licensed or otherwise authorized to access one or more encrypted pieces of content, the DRM manager can prevent the client 12, or more particularly the access application (i.e., software application 26) from accessing any of the provided encrypted, piece(s) of content and, if so desired, can inform the access application, and thus the client user, that a license is required to access such content. On the other hand, if the client user is licensed or otherwise authorized to access one or more encrypted pieces of content, the DRM manager 16 can store the client ID in the user database associated with the client user, and generate a license file to facilitate the access application in accessing such content. As shown in block 48, for example, the DRM manager 16 can generate a license file that includes the client ID received from the client 12, as well as one or more symmetric keys required to access the encrypted piece(s) of content provided to the client, for which the client is licensed or otherwise authorized to access.

As shown in block 50, after generating the license file, the DRM manager 16 can encrypt the license file. As will be appreciated, the DRM manager 16 can encrypt the license file in any of a number of different manners. For example, the DRM manager 16 can encrypt the license file using the public key of the public key/private key pair including the private key previously provided to the client 12. Alternatively, the DRM manager 16 can encrypt the license file using a random symmetric key, and encrypt the random symmetric key with the public key of the public key/private key pair including the private key previously provided to the client 12. Irrespective of how the DRM manager 16 encrypts the license file, the DRM manager can thereafter transfer the encrypted license file to the client 12, or more particularly the access application (i.e., software application 26), as shown in block 52.

Upon receipt of the encrypted license file, the client 12 or access application (i.e., software application 26) can decrypt the license file using the private key previously provided to the client, as shown in block 54. Alternatively, the access application can decrypt the random symmetric key using the private key, and thereafter decrypt the license file using the decrypted, random symmetric key. After decrypting the license file, then, the access application can determine if the client 12 is authorized to decrypt the encrypted piece(s) of content based upon the client ID included in the license file. In this regard, the access application can identify the client ID included in the license file, and determine if that client ID matches the client ID of the client 12 operating the access application. If a match is not identified, the access application can refuse to decrypt the encrypted piece(s) of content provided to the client 12. However, if a match is identified, thus authorizing the client 12 of the respective client user to decrypt the encrypted piece(s) of content, the access application can copy the encrypted piece(s) of content to a temporary location in memory (i.e., memory 22) of the client. Then, the access application can decrypt the copy of the encrypted piece(s) of content for which the client user is licensed or otherwise authorized to access using the symmetric key(s) included in the decrypted license file, as shown in block 58. Thereafter, the access application can access the decrypted piece(s) of content, as shown in block 60. For example, the access application can render the piece(s) of content for display to the client user.

After the client user has finished with the decrypted piece(s) of content, the client 12 or client user can close access to the decrypted piece(s) of content. For example, the client user can close the access application (i.e., software application 26) rendering the decrypted piece(s) of content, or close the presentation of the decrypted piece(s) of content within the access application. Irrespective of how the client 12 or client user closes access to the decrypted piece(s) of content, as the client user closes access to the decrypted piece(s) of content, the access application can be configured to delete or otherwise remove the decrypted piece(s) of content from the temporary location in memory of the client. Thus, each time the client user attempts to access the same or different piece(s) of content provided by the source 12, the DRM technique of embodiments of the present invention may be applied again before permitting the client user to access the piece(s) of content, such as in the same manner described above.

Instead of requiring the access application to repeatedly transfer the username/password and client ID to the DRM manager 16, however, for each subsequent access of the same encrypted piece(s) of content, the access application can be configured to begin by determining if the client 12 is authorized to decrypt the encoded piece(s) of content. In this regard, the access application can be configured to again determine if the client ID included in the previously received license file matches the client ID of the client 12 attempting to decode the encrypted piece(s) of content. Then, in those instances where the client ID included in the previously received license file does not match the client ID of the respective client 12, the access application can be configured to again requesting access to the respective piece(s) of content by transferring the username/password and client ID to the DRM manager 16, and proceeding through the DRM process as explained above.

Each subsequent time the DRM manager 16 sends an encrypted license file to a client 12 or access application (i.e., software application 26) to access encrypted piece(s) of content, the DRM manager can be configured to include, in each license file, the client ID associated with the client user in the user database, as opposed to a client ID transferred to the DRM manager from the client 12. In this regard, the DRM manager 16 can reduce, if not eliminate, instances of an unauthorized client decoding the encrypted piece(s) of content. For example, the DRM manager 16 can reduce instances of a client user giving the client user's username/password to an another, unauthorized client user of another client, which thereafter attempts to access the encrypted piece(s) of content. As will be appreciated, the client user can be freely permitted to give or otherwise transfer the encrypted piece(s) of content to other client users. However, because the DRM manager 16 controls the symmetric key(s) used to decrypt such content, and the access application controls the decryption of such content, the DRM manager and access application can permit only those client users licensed or otherwise authorized to access encrypted piece(s) of content to access such content.

As will also be appreciated, the same client user may be permitted to access the encrypted piece(s) of content from more than one client 12, such as from a predefined number of clients, if so desired. In such instances, the DRM manager 16 can operate as described above, receiving a username/password and client ID from a client 12, or more particularly an access application (i.e., software application 26) operating on the client, and storing the respective client ID in the user database associated with the client user. Then, if the number of different client IDs associated with the client user does not exceed the predefined number of clients 12, the DRM manager 16 can proceed to generate and encrypt a license file including the most recently received client ID, and transfer the encrypted license file to the client. If the number of client IDs exceeds the predefined number of clients 12, however, the DRM manager 16 can refuse to send an encrypted license file to the client and, if so desired, can inform the client that the respective encrypted piece(s) of content have previously been accessed from a maximum number of clients. Then, to reduce the number of client IDs associated with the client user below the predefined number of clients 12, the client user can communicate with the DRM manager 16 to remove the client ID of a previous client from the user database, thereby permitting the respective client user to access the respective encrypted piece(s) of content from another client. For example, the client user can uninstall or otherwise remove the access application from a client 12, and as the access application is removed, communicate with the DRM manager 16 to remove the client ID of the respective client from the user database.

To further illustrate the benefits of embodiments of the present invention, consider a DVD provided to a plurality of students (i.e., client users) of a university. The DVD stores curriculum materials, including a textbook, lab workbook and a packet of professor notes, for a class being taken by the students at the university, and also stores a viewer application (i.e., access application) for presenting the curriculum materials for display to the student. Also, consider that the source 14 of the DVD encrypted each piece of curriculum materials (i.e., textbook, lab workbook and packet of notes) with a separate symmetric key. Needing the curriculum materials for the class being taken by the student, the students have purchased a license to access the curriculum materials, and have accordingly been provided with separate usernames/passwords and private keys from a licensing server (i.e., DRM manager 16). In this regard, each student can install the viewer application on the respective student's personal computer (PC) (i.e., client 12), and operate the viewer application to communicate with the licensing server across the Internet (i.e., network 18). During such communication, then, the student can register with the licensing server, providing the licensing server with information sufficient to inform the licensing server of the curriculum materials the client user is licensed to access such that the licensing server can verify the license. After the student has successfully registered with the licensing server, the licensing server can transfer the student's username/password and private key to the student's PC.

After receiving a username/password and private key, a student (i.e., client user) can instruct the respective student's PC (i.e., client 12) to execute the viewer application for operation. In such instances, the student then instructs the viewer application to access one or more of the encrypted pieces of curriculum materials (i.e., textbook, lab workbook and/or packet of notes) stored on the DVD. Before accessing the encrypted curriculum materials, however, the viewer application authenticates the student to the licensing server by transferring the student's username/password to the licensing server (i.e., DRM manager 16). In addition, the viewer application transfers a machine ID of the student's PC to the licensing server such that the student's PC can thereafter be authorized to decode the curriculum materials. Upon receipt of the username/password and machine ID, the licensing server determines what, if any, pieces of curriculum materials the student is licensed to access. Determining that the student is licensed to access a textbook, lab workbook and packet of notes, the licensing server generates, and thereafter encrypts, a license file that includes the machine ID of the student's PC and three symmetric keys, one for each piece of content licensed for access by the student.

The licensing server (i.e., DRM manager 16) transfers the encrypted license file to the student's PC (i.e., client 12), or more particularly the viewer application operating on the student's PC. After decrypting the license file, the viewer application identifies the machine ID included in the license file, and attempts to authorize the student's PC to decode the curriculum material by determining if that machine ID matches the machine ID of the student's PC. If the viewer application identifies a match, then, the viewer application decrypts the curriculum materials the student instructed the viewer application to access, using the symmetric key(s) used to encrypt the respective curriculum materials and included in the decrypted license file. Thereafter, the viewer application accesses the decrypted curriculum materials, such as by rendering the decrypted curriculum materials for display to the student.

According to one aspect of the present invention, all or a portion of the system 10 of embodiments of the present invention, such as all or portions of the client 12, source 14 and/or DRM manager 16 generally operates under control of a computer program product (i.e., application(s) 26). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 3A, 3B and 4 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that each block or step of the flowcharts, and combinations of block(s) or step(s) in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for providing digital rights management (DRM) of protected content, the system comprising:
a client capable of receiving at least one piece of content, wherein the client has a client user associated therewith, and wherein the at least one piece of content is encrypted with at least one encryption key regardless of any client user authorized to access the at least one piece of encrypted content;
a DRM manager capable of transferring the at least one encryption key to the client, the at least one encryption key being encrypted with a private key of a public key/private key pair unique to the client user associated with the client; and
wherein the client is capable of decrypting the at least one encryption key using the public key of the public key/private key pair unique to the client user, decrypting the at least one piece of content using the decrypted at least one encryption key, and accessing the decrypted at least one piece of content.

2. A system according to claim 1, wherein the DRM manager is capable of determining if the client user is authorized to access the at least one piece of content before transferring the at least one encryption key at the client, and if the client user is authorized, transferring the at least one encryption key to the client.

3. A system according to claim 1, wherein the client is capable of operating an access application, the access application being capable of determining if the client is authorized to decrypt the at least one piece of content, and if the client is authorized, decrypting the at least one piece of content and accessing the decrypted at least one piece of content.

4. A system according to claim 3, wherein the access application is capable of determining if the client is authorized to decrypt the at least one piece of content based upon a client identifier uniquely identifying the client.

5. A system according to claim 4, wherein each of a plurality of clients have a client identifier uniquely identifying the respective client;
wherein the client is capable of receiving a license file including the at least one encryption key and a client identifier uniquely identifying the same or a different client, the license file being encrypted with the private key;
wherein the access application is capable of decrypting the license file including the at least one encryption key and the client identifier; and
wherein the access application is capable of determining if the client is authorized to decrypt the at least one piece of content based upon the client identifier in the license file and the client identifier of the client receiving the license file.

6. A system according to claim 5, wherein the access application is capable of determining if the client identifier in the license file matches the client identifier of the client receiving the license file, and if a match is identified, decrypting the at least one piece of content and accessing the decrypted at least one piece of content.

7. A system according to claim 1, wherein the client is capable of receiving a plurality of pieces of content, the plurality of pieces of content being encrypted with a plurality of encryption keys;
wherein the DRM manager is capable of transferring the plurality of encryption keys to the client; and
wherein the client is capable of decrypting the plurality of encryption keys, and for each of the plurality of pieces of content, decrypting the respective piece of content using a respective decrypted encryption key.

8. A digital rights management (DRM) manager for providing digital rights management of at least one piece of protected content, wherein the at least one piece of content is provided to a client having a client user associated therewith, wherein the at least one piece of content is encrypted with at least one encryption key regardless of any client user authorized to access the at least one piece of encrypted content, and wherein the DRM manager comprises:
a processor capable of transferring the at least one encryption key to the client, the at least one encryption key being encrypted with a private key of a public key/private key pair unique to the client user associated with the client, wherein the processor is capable of transferring the at least one encryption key to the client such that the client is thereafter capable of decrypting the at least one encryption key using the public key of the public key/private key pair unique to the client user, decrypting the at least one piece of content using the decrypted at least one encryption key, and accessing the decrypted at least one piece of content.

9. A DRM manager according to claim 8, wherein the processor is capable of determining if the client user is authorized to access the at least one piece of content before transferring the at least one encryption key at the client, and if the client user is authorized, transferring the at least one encryption key to the client.

10. A DRM manager according to claim 8, wherein the processor is capable of transferring the at least one encryption key to the client such that an access application capable of operating on the client is thereafter capable of determining if the client is authorized to decrypt the at least one piece of content, and if the client is authorized, decrypting the at least one piece of content and accessing the decrypted at least one piece of content.

11. A DRM manager according to claim 10, wherein the processor is capable of transferring the at least one encryption key to the client such that the access application is capable of determining if the client is authorized to decrypt the at least one piece of content based upon a client identifier uniquely identifying the client.

12. A DRM manager according to claim 11, wherein each of a plurality of clients have a client identifier uniquely identifying the respective client;
wherein the processor is capable of sending the client a license file including the at least one encryption key and a client identifier uniquely identifying the same or a different client, the license file being encrypted with the private key; and
wherein the processor is capable of sending the license file such that the access application is capable of decrypting the license file including the at least one encryption key and the client identifier, and thereafter determining if the client is authorized to decrypt the at least one piece of content based upon the client identifier in the license file and the client identifier of the client receiving the license file.

13. A DRM manager according to claim 12, wherein the processor is capable of sending the license file such that the access application is capable of determining if the client identifier in the license file matches the client identifier of the client receiving the license file, and if a match is identified, decrypting the at least one piece of content and accessing the decrypted at least one piece of content.

14. A DRM manager according to claim 8, wherein the client is capable of receiving a plurality of pieces of content, the plurality of pieces of content being encrypted with a plurality of encryption keys; and
wherein the processor is capable of transferring the plurality of encryption keys to the client such that the client is capable of decrypting the plurality of encryption keys, and for each of the plurality of pieces of content, decrypting the respective piece of content using a respective decrypted encryption key.

15. A client having a client user associated therewith, the client comprising:
a processor capable of operating an access application, wherein the access application is capable of receiving at least one piece of content, the at least one piece of content being encrypted with at least one encryption key regardless of any client user authorized to access the at least one piece of encrypted content;
wherein the access application is capable of receiving the at least one encryption key, the at least one encryption key being encrypted with a private key of a public key/private key pair unique to the client user associated with the client; and
wherein the access application is also capable of decrypting the at least one encryption key using the public key of the public key/private key pair unique to the client user, decrypting the at least one piece of content using the decrypted at least one encryption key, and thereafter accessing the decrypted at least one piece of content.

16. A client according to claim 15, wherein the access application is capable of receiving the at least one encryption key if the client user is authorized to access the at least one piece of content.

17. A client according to claim 15, wherein the access application is further capable of determining if the client is authorized to decrypt the at least one piece of content, and if the client is authorized, decrypting the at least one piece of content and accessing the decrypted at least one piece of content.

18. A client according to claim 17, wherein the access application is capable of determining if the client is authorized to decrypt the at least one piece of content based upon a client identifier uniquely identifying the client.

19. A client according to claim 18, wherein each of a plurality of clients have a client identifier uniquely identifying the respective client, wherein the client application is capable of receiving a license file including the at least one encryption key and a client identifier uniquely identifying the same or a different client, the license file being encrypted with the private key;
wherein the access application is capable of decrypting the license file including the at least one encryption key and the client identifier; and
wherein the access application is capable of determining if the client is authorized to decrypt the at least one piece of content based upon the client identifier in the license file and the client identifier of the client receiving the license file.

20. A client according to claim 19, wherein the access application is capable of determining if the client identifier in the license file matches the client identifier of the client receiving the license file, and if a match is identified, decrypting the at least one piece of content and accessing the decrypted at least one piece of content.

21. A client according to claim 15, wherein the access application is capable of receiving a plurality of pieces of content at a client, the plurality of pieces of content being encrypted with a plurality of encryption keys;
wherein the access application is capable of receiving the plurality of encryption keys, and decrypting the plurality of encryption keys; and
wherein the access application is capable of decrypting at least one of the plurality of pieces of content, and for each respective piece of content, decrypting the respective piece of content using a respective decrypted encryption key.

22. A method of providing digital rights management of protected content, the method comprising:
receiving at least one piece of content at a client, the client having a client user associated therewith, the at least one piece of content being encrypted with at least one encryption key regardless of any client user authorized to access the at least one piece of encrypted content;
receiving the at least one encryption key at the client, the at least one encryption key being encrypted with a private key of a public key/private key pair unique to the client user associated with the client;
decrypting the at least one encryption key using the public key of the public key/private key pair unique to the client user;
decrypting the at least one piece of content using the decrypted at least one encryption key; and
accessing the decrypted at least one piece of content.

23. A method according to claim 22 further comprising:
determining if the client user is authorized to access the at least one piece of content before receiving the at least one encryption key at the client; and
if the client user is authorized, transferring the at least one encryption key to the client.

24. A method according to claim 22 further comprising:
determining if the client is authorized to decrypt the at least one piece of content, and if the client is authorized, decrypting the at least one piece of content and accessing the decrypted at least one piece of content.

25. A method according to claim 24, wherein determining if the client is authorized to decrypt the at least one piece of content comprises determining if the client is authorized to decrypt the at least one piece of content based upon a client identifier uniquely identifying the client.

26. A method according to claim 25, wherein each of a plurality of clients have a client identifier uniquely identifying the respective client;
wherein receiving the at least one encryption key at the client comprises receiving a license file including the at least one encryption key and a client identifier uniquely identifying the same or a different client, the license file being encrypted with the private key;
wherein decrypting the at least one encryption key comprises decrypting the license file including the at least one encryption key and the client identifier; and
wherein determining if the client is authorized to decrypt the at least one piece of content comprises determining if the client is authorized to decrypt the at least one piece of content based upon the client identifier in the license file and the client identifier of the client receiving the license file.

27. A method according to claim 26, wherein determining if the client is authorized to decrypt the at least one piece of content comprises determining if the client identifier in the license file matches the client identifier of the client receiving the license file, and if a match is identified, decrypting the at least one piece of content and accessing the decrypted at least one piece of content.

28. A method according to claim 22, wherein receiving at least one piece of content comprises receiving a plurality of pieces of content at a client, the plurality of pieces of content being encrypted with a plurality of encryption keys;
wherein receiving the at least one encryption key comprises receiving the plurality of encryption keys, and decrypting the at least one encryption key comprises decrypting the plurality of encryption keys; and
wherein decrypting the at least one piece of content comprises decrypting at least one of the plurality of pieces of content, and for each respective piece of content, decrypting the respective piece of content using a respective decrypted encryption key.

29. A computer program product for providing digital rights management of protected content, wherein the computer program product comprises at least one computer-readable storage medium having computer-readable program code portions stored therein, the computer-readable program code portions comprising:
a first executable portion for receiving at least one piece of content, the at least one piece of content being encrypted with at least one encryption key regardless of any client user authorized to access the at least one piece of encrypted content;
a second executable portion for receiving the at least one encryption key, the at least one encryption key being encrypted with a private key of a public key/private key pair unique to a client user associated with a client;
a third executable portion for decrypting the at least one encryption key using the public key of the public key/private key pair unique to the client user;
a fourth executable portion for decrypting the at least one piece of content using the decrypted at least one encryption key; and
a fifth executable portion for accessing the decrypted at least one piece of content.

30. A computer program product according to claim 29, wherein the second executable portion is adapted to receive the at least one encryption key if the client user is authorized to access the at least one piece of content.

31. A computer program product according to claim 29 further comprising:
a sixth executable portion for determining if the client is authorized to decrypt the at least one piece of content; and
wherein the fourth executable portion is adapted to decrypt the at least one piece of content, and the fifth executable portion is adapted to access the decrypted at least one piece of content, if the client is authorized.

32. A computer program product according to claim 31, wherein the sixth executable portion is adapted to determine if the client is authorized to decrypt the at least one piece of content based upon a client identifier uniquely identifying the client.

33. A computer program product according to claim 32, wherein each of a plurality of clients have a client identifier uniquely identifying the respective client, wherein the second executable portion is adapted to receive a license file including the at least one encryption key and a client identifier uniquely identifying the same or a different client, the license file being encrypted with the private key;
wherein the third executable portion is adapted to decrypt the license file including the at least one encryption key and the client identifier; and
wherein the sixth executable portion is adapted to determine if the client is authorized to decrypt the at least one piece of content based upon the client identifier in the license file and the client identifier of the client receiving the license file.

34. A computer program product according to claim 33, wherein the sixth executable portion is adapted to determine if the client identifier in the license file matches the client identifier of the client receiving the license file; and
wherein the fourth executable portion is adapted to decrypt the at least one piece of content, and the fifth executable portion is adapted to access the decrypted at least one piece of content, if a match is identified.

35. A computer program product according to claim 29, wherein the first executable portion is adapted to receive a plurality of pieces of content at a client, the plurality of pieces of content being encrypted with a plurality of encryption keys;
wherein the second executable portion is adapted to receive the plurality of encryption keys, and the third executable portion is adapted to decrypt the plurality of encryption keys; and
wherein the fourth executable portion is adapted to decrypt at least one of the plurality of pieces of content, and for each respective piece of content, decrypting the respective piece of content using a respective decrypted encryption key.
